(19) United States
(12) Patent Application Publication
(10) Pub. No.: US 2026/0147834 A1
(43) Pub. Date: May 28, 2026

(54) OBJECT REIDENTIFICATION AND ASSOCIATED DATA RETRIEVAL, AND RELATED SYSTEMS, DEVICES, UNITS, AND METHODS

(71) Applicant: LiveView Technologies, LLC, American Fork, UT (US)

(72) Inventor: Michael Nelson Abbott, American Fork, UT (US)

(21) Appl. No.: 18/959,283

(22) Filed: Nov. 25, 2024

(51) Int. Cl. G06F 16/783; G06F 16/56

(52) U.S. Cl. CPC G06F 16/7837; G06F 16/56

(57) ABSTRACT

Various embodiments relate to mobile surveillance systems. A system may include a mobile surveillance unit including at least one camera for capturing data including one or more objects. The mobile surveillance unit may further include an application program including an artificial intelligence (AI) model for generating first metadata for at least one object of the one or more objects. The mobile surveillance unit further includes a database for storing the first metadata and a communication device for receiving second metadata. The application program may be configured to: compare the second metadata to the first metadata; retrieve output data responsive to the second metadata matching the first metadata; and cause the output data to be conveyed to a remote device via the communication device. Associated methods are also disclosed.

### TECHNICAL FIELD

This disclosure relates generally to object reidentification and, more specifically, to distributed object reidentification across a number of remote units, associated data retrieval, and to related systems, devices, units, and methods.

### BACKGROUND

Reidentification systems are artificial intelligence (AI) systems that use biometrics to identify objects (e.g., people, vehicles, animals, etc.) across multiple camera views. Reidentification systems are used in a variety of applications, such as, security and surveillance (e.g., identifying and/or tracking offenders and/or suspicious activity), missing persons (e.g., locating a missing person), and public services, among others.

### BRIEF SUMMARY

At least one embodiment of the disclosure includes a system. The system includes a server and a number of mobile units communicatively coupled to the server. Each mobile unit of the number of mobile units includes at least one camera for capturing data including objects. Further, each mobile unit includes a first model for generating a number of first vector representations based on the objects of the captured data. Each mobile unit may include at least one database for storing the captured data and the number of first vector representations. Further, each mobile unit includes a communication device for receiving a second vector representation. Each mobile unit may also include at least one application program configured to: compare the second vector representation to each of the number of first vector representations; identify associated data of a specific vector representation of the first vector representations responsive to a match between the second vector representation and the specific vector representation; and cause the associated data to be sent to a device via the communication device.

Another embodiment includes a system including a mobile surveillance unit. The mobile surveillance unit may include at least one camera for capturing data including one or more objects. The mobile surveillance unit may further include an application program including an artificial intelligence (AI) model for generating first metadata for at least one object of the one or more objects. The mobile surveillance unit further includes a database for storing the first metadata and a communication device for receiving second metadata. The application program may be configured to: compare the second metadata to the first metadata; retrieve output data responsive to the second metadata matching the first metadata; and cause the output data to be conveyed to a remote device via the communication device.

Another embodiment includes a method of operating a surveillance system. The method may include capturing data including one or more first objects via at least one camera of a mobile unit. The method may also include storing the data and first metadata at the mobile unit, the first metadata representing the one or more first objects. Further, the method may include receiving, at the mobile unit, second metadata representing a second object. The method may further include comparing, at the mobile unit, the second metadata to the first metadata. Moreover, the method may include generating, via the mobile unit, output data responsive to the second metadata matching the first metadata. Additionally, the method may include conveying the output data from the mobile unit to a remote device.

In yet another embodiment, a method of operating a surveillance system may include receiving data including or identifying one or more objects. The method may also include generating a vector representation of the one or more objects. Further, the method may include conveying the vector representation to a number of units. Additionally, the method may include comparing, at each of the number of units, the vector representation to each of a number of second vector representations. The method may further include generating, via at least one unit of the number of units, output data responsive to the vector representation matching at least one second vector representation of the number of second representations. Moreover, the method may include conveying the output data from the at least one unit to a remote device.

### BRIEF DESCRIPTION OF THE DRAWINGS

FIG. 1 depicts an example system including a unit, in accordance with various embodiments of the disclosure.

FIG. 2 depicts another example system including a unit, in accordance with various embodiments of the disclosure.

FIGS. 3A-3C depict an example system including a user device and a number of units, in accordance with various embodiments of the disclosure.

FIG. 4 depicts an example system including a mobile unit, a server, and one or more devices, in accordance with various embodiments of the disclosure.

FIG. 5 illustrates another example system, according to one or more embodiments of the disclosure.

FIG. 6 is a flowchart illustrating an example method, according to various embodiments of the disclosure.

FIG. 7 is a flowchart illustrating another example method, according to various embodiments of the disclosure.

### DETAILED DESCRIPTION

Referring in general to the accompanying drawings, various embodiments of the present invention are illustrated to show example embodiments related to object reidentification and associated data retrieval. It should be understood that the drawings presented are not meant to be illustrative of actual views of any particular portion of an actual circuit, device, system, or structure, but are merely representations which are employed to more clearly depict various embodiments of the disclosure.

The following provides a more detailed description of the present invention and various representative embodiments thereof. In this description, functions may be shown in block diagram form in order not to obscure the present invention in unnecessary detail. Additionally, block definitions and partitioning of logic between various blocks is exemplary of a specific implementation. It will be readily apparent to one of ordinary skill in the art that the present invention may be practiced by numerous other partitioning solutions. For the most part, details concerning timing considerations and the like have been omitted where such details are not necessary to obtain a complete understanding of the present invention and are within the abilities of persons of ordinary skill in the relevant art.

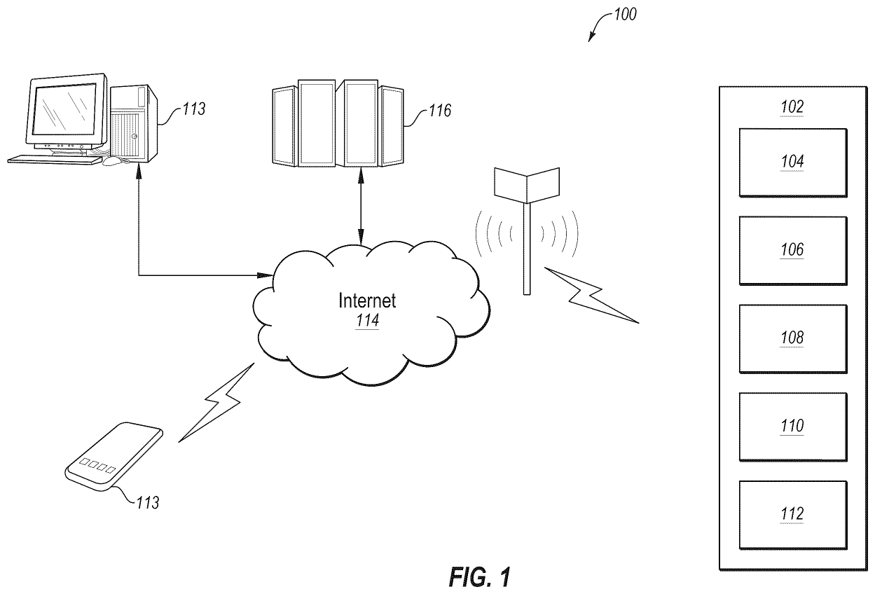

FIG. 1 illustrates a system 100, according to one or more embodiments of the disclosure. System 100, which may include a security and/or surveillance system, includes a unit 102, which may also be referred to herein as a “mobile unit,” a “mobile security unit,” a “mobile surveillance unit,” a “physical unit,” or some variation thereof. According to various embodiments, unit 102 may include one or more sensors 104 (e.g., cameras, weather sensors, motion sensors, noise sensors, chemical sensors, without limitation) and one or more output devices 106 (e.g., lights, speakers, electronic displays, without limitation). For example only, sensors 104 may include one or more cameras, such as thermal cameras, infrared cameras, optical cameras, PTZ cameras, bi-spectrum cameras, any other camera, or any combination thereof. Further, for example only, output devices 106 may include one or more lights (e.g., flood lights, strobe lights (e.g., LED strobe lights), and/or other lights), one or more speakers (e.g., loudspeakers, two-way public address (PA) speaker systems, or any other suitable speaker), any other suitable output device (e.g., a digital display), or any combination thereof.

In some embodiments, unit 102 may also include one or more storage devices 108. Storage device 108, which may include any suitable storage device (e.g., a memory card, hard drive, a digital video recorder (DVR)/network video recorder (NVR), internal flash media, a network attached storage device, or any other suitable electronic storage device), may be configured for receiving and storing data (e.g., video, images, and/or i-frames) captured by sensors 104. In some embodiments, during operation, storage device 108 may continuously record data (e.g., video, images, i-frames, and/or other data) captured by one or more sensors 104 (e.g., cameras, lidar, radar, RF sensors, environmental sensors, acoustic sensors, without limitation) of unit 102 (e.g., 24 hours a day, 7 days a week, or any other time scenario).

Unit 102 may further include a computer 110, which may include memory and/or any suitable processor, controller, logic, and/or other processor-based device known in the art. Computer 110 may include an operating system (e.g., installed on a hard drive). Moreover, although not shown in FIG. 1, unit 102 may include one or more additional devices including, but not limited to, one or more microphones, one or more solar panels, one or more power generators (e.g., fuel cell generators), or any combination thereof. Unit 102 may also include a communication device 112, which may comprise any suitable and known communication device (e.g., a modem (e.g., a cellular modem, a satellite modem, a Wi-Fi modem, etc.)). In some embodiments, communication device 112 may include one or more radios and/or one or more antennas. As will be appreciated, components of unit 102 may be suitably coupled via wired connections, wireless connections, or a combination thereof.

System 100 may further include one or more electronic devices 113, which may comprise, for example only, a mobile device (e.g., mobile phone, tablet, etc.), a laptop computer, a desktop computer, or any other suitable electronic device (e.g., a user device) including a display. Electronic device 113 may be accessible to one or more end-users. Additionally, system 100 may include a server 116 (e.g., a cloud server), which may be remote from unit 102. Communication device 112, electronic devices 113, and server 116 may be coupled to one another via the Internet 114 (e.g., via a cellular connection).

According to various embodiments of the disclosure, unit 102 may be within a first location (a “camera location” or a “unit location”), and server 116 may be within a second location, remote from the first location. In addition, each electronic device 113 may or may not be remote from unit 102 and/or server 116. As will be appreciated by a person having ordinary skill in the art, system 100 may be modular, expandable, and/or scalable.

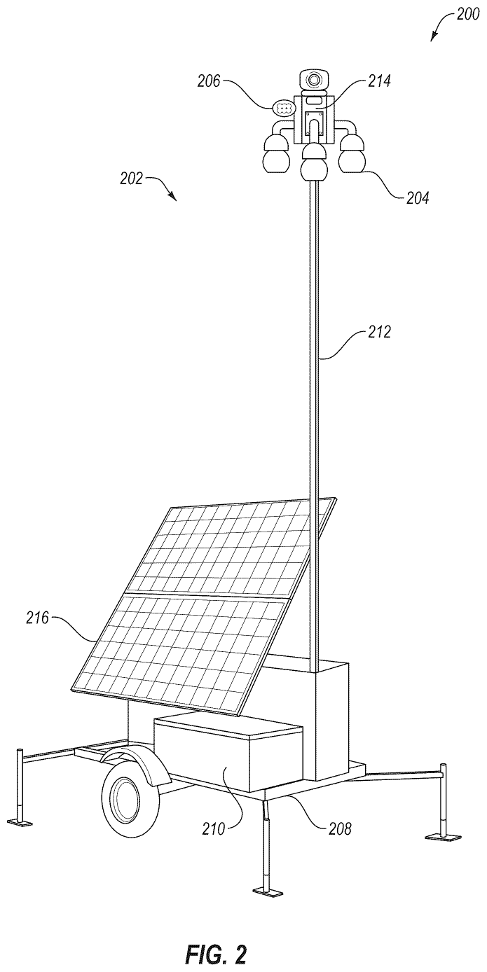

As noted above, in some embodiments, unit 102 may include a mobile unit (e.g., a mobile security/surveillance unit). In these and other embodiments, unit 102 may include a portable trailer (not shown in FIG. 1; see FIG. 2), a storage box (e.g., including one or more batteries) (not shown in FIG. 1; see FIG. 2), and a mast (not shown in FIG. 1; see FIG. 2) coupled to a head unit (e.g., including, for example, one or more cameras, one or more lights, one or more speakers, and/or one or more microphones) (not shown in FIG. 1; see FIG. 2). According to various examples, in addition to sensors and output devices, a head unit of unit 102 may include and/or be coupled to storage device 108, computer 110, and/or communication device 112.

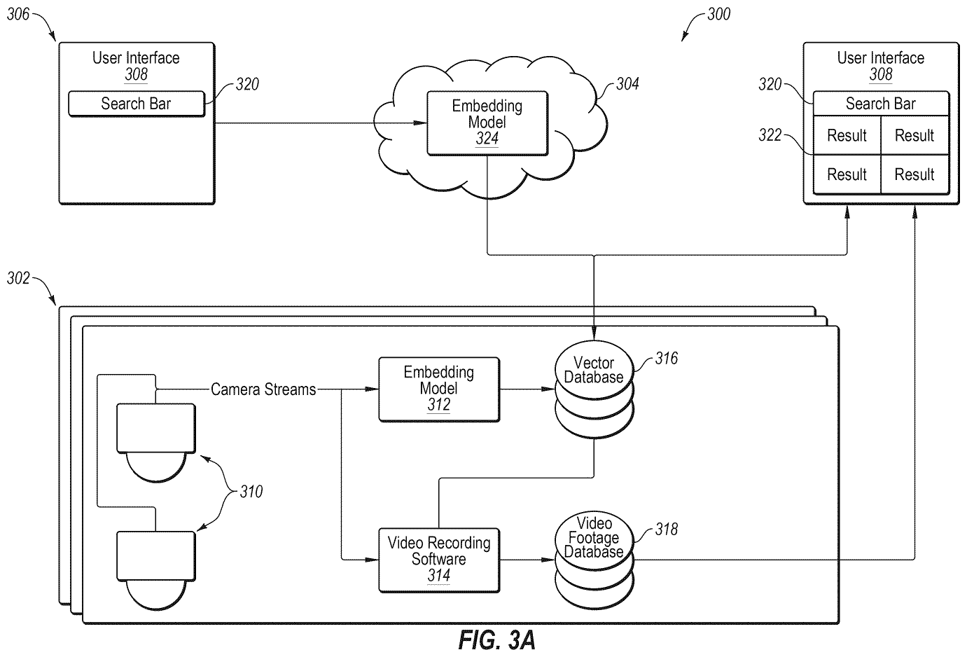

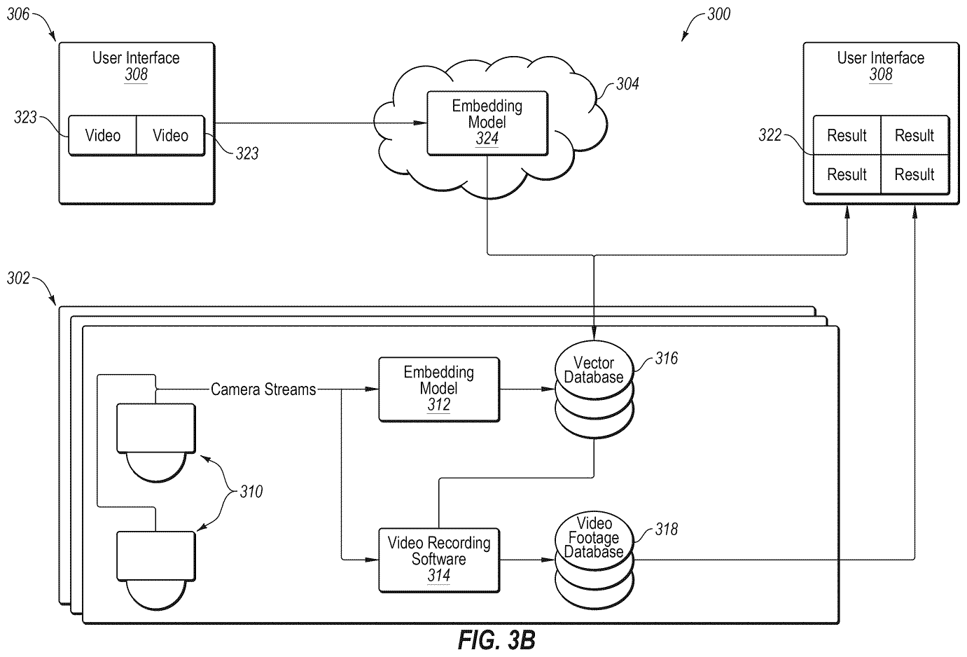

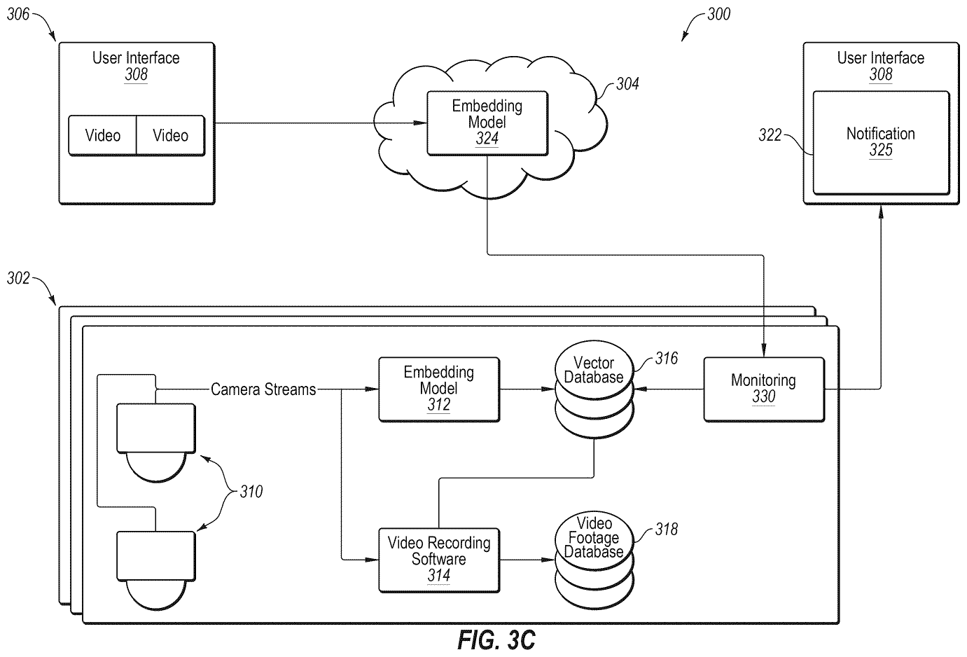

FIG. 2 depicts another example system 200 including a unit 202, in accordance with various embodiments of the disclosure. Unit 202, which may also be referred to herein as a “mobile unit,” a “mobile security unit,” a “mobile surveillance unit,” or a “physical unit,” may be configured to be positioned in an environment (e.g., a parking lot, a roadside location, a construction zone, a concert venue, a sporting venue, a school campus, without limitation). In some embodiments, unit 202 may include one or more sensors 204 (e.g., cameras, weather sensors, motion sensors, noise sensors, without limitation) and one or more output devices 206 (e.g., lights, speakers, electronic displays, without limitation). For example, sensors 204 may include one or more cameras, such as cameras 310 shown in FIGS. 3A-3C.

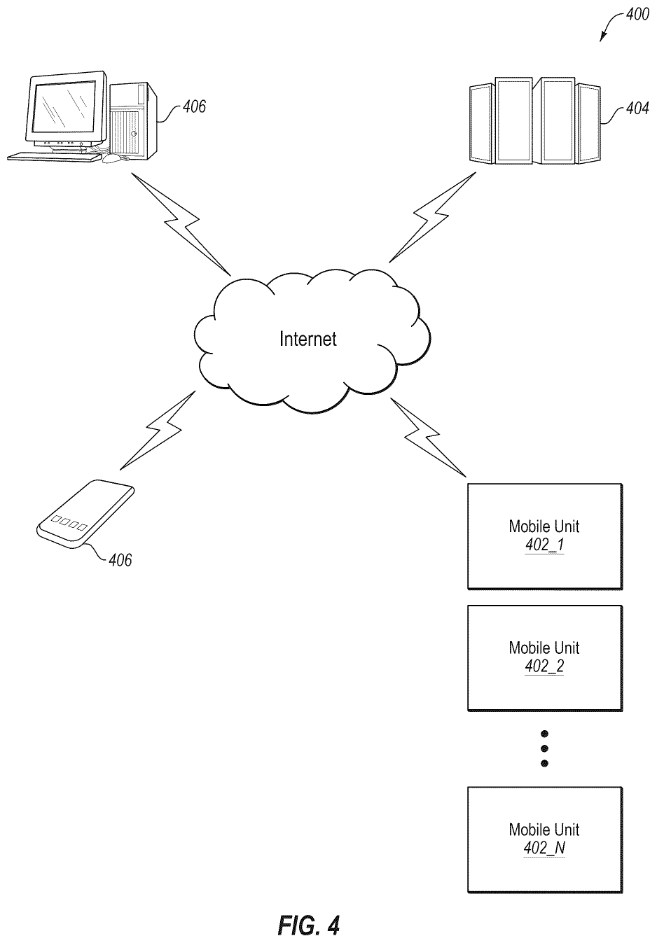

Unit 202 may also include at least one storage device (e.g., internal flash media, a network attached storage device, or any other suitable electronic storage device), which may be configured for receiving and storing data (e.g., video, images, audio, without limitation) captured by one or more sensors of unit 202. According to some embodiments, unit 202 may include unit 102 of FIG. 1, a mobile unit 302 shown in FIGS. 3A-3C, and/or a mobile unit 402 shown in FIG. 4.

In some embodiments, unit 202 may include a mobile unit. In these and other embodiments, mobile unit 402 may include a portable trailer 208, a storage box 210, and a mast 212 coupled to a head unit (also referred to herein as a “live unit,” an “edge device,” or simply an “edge”) 214, which may include (or be coupled to) for example, one or more batteries, one or more cameras, one or more lights, one or more speakers, one or more microphones, and/or other input and/or output devices. According to some embodiments, a first end of mast 212 may be proximate storage box 210 and a second, opposite end of mast 212 may be proximate, and possibly adjacent, head unit 214. More specifically, in some embodiments, head unit 214 may be coupled to mast 212 an end opposite an end of mast 212 proximate storage box 210.

In some examples, unit 202 may include one or more primary batteries (e.g., within storage box 210) and one or more secondary batteries (e.g., within head unit 214). In these embodiments, a primary battery positioned in storage box 210 may be coupled to a load and/or a secondary battery positioned within head unit 214 via, for example, a cord reel.

In some embodiments, unit 202 may also include one or more solar panels 216, which may provide power to one or more batteries of unit 202. More specifically, according to some embodiments, one or more solar panels 216 may provide power to a primary battery within storage box 210. Although not illustrated in FIG. 2, unit 202 may include one or more other power sources, such as one or more generators (e.g., fuel cell generators) (e.g., in addition to or instead of solar panels).

As will be appreciated, reidentification (ReID) systems may determine whether, for example, a detected object (e.g., a person, such as a person-of-interest) has been detected at another location (e.g., by a different camera) or at the same location at a different time. Conventional ReID systems, which may include a number of devices (e.g., including cameras) and a server, use a centralized database at the server. In these conventional ReID systems, data (e.g., video data and/or image data) captured by a device (e.g., a camera) is uploaded to the server, wherein a centralized model may compare objects (e.g., persons depicted in the data) to known objects (e.g., persons depicted in stored data) in the centralized database to detect matches. As will be appreciated, sending image data and/or video data over a network (e.g., a cellular or satellite network) to a centralized database may be expensive.

According to various embodiments of the disclosure, rather than uploading data (e.g., images and/or video) to and detecting matches in a centralized location, an edge device, which may include a model for generating a point in vector space (i.e., representing on object detected in image data and/or video data), may store metadata (e.g., vector representations of detected objects) locally. Further, the edge device may receive metadata from one or more other devices (e.g., edge devices, servers, user devices, etc.), and the edge device may then compare the received metadata to its stored metadata (i.e., to identify matches of objects detected at respective devices). In one example, a point representing an object (e.g., a person) that was detected by one edge device may be sent to a number of other edge devices to compare and identify any matches that may exist. In some embodiments, as described more fully below, a user may provide and/or identify input that may be used to generate a vector representation of an object. Further, timestamps representing a matching point may be sent to a device (e.g., a server, user device, and/or edge device). As will be appreciated, a point representing an object may be a relatively small piece of data compared to a video and/or an image of the object. Accordingly, an amount of data transfer (e.g., cellular data) and cloud computing costs may be significantly reduced, while providing a very enhanced experience for gathering forensic data.

FIG. 3A-3C depicts an example system 300, in accordance with various embodiments of the disclosure. System 300 includes a number of units 302 (e.g., unit 102 and/or unit 202), a server 304, and a user device 306 including a user interface 308.

Units 302 may include a number (e.g., a fleet) of mobile units (e.g., mobile surveillance units (also referred to herein as “mobile security units”)), wherein at least some of units 302 include input devices (e.g., cameras, microphone, other sensors, without limitation) and output devices (e.g., speakers, lights, displays, without limitation). As illustrated in FIG. 3, units 302 include cameras 310, a model (e.g., an embedding model) 312, a video recorder system (e.g., video recorder program) 314, a database (e.g., a vector database) 316, and a database (e.g., video footage database) 318. Further, server 304 may include a model (e.g., an embedding model) 324.

Among other features, user interface 308 may include a search bar 320 and a display 322 for displaying data (e.g., video data, image data, and/or text data, without limitation). For example, in the embodiment of FIG. 3A, display 322 may display one or more search results (e.g., videos identified based on a search (e.g., performed by a user using search bar 320)). Further, as shown in FIGS. 3B and 3C, display 322 may display one or more videos 323, which may be selected by a user of user interface 308, as described more fully below. Further, as shown in FIG. 3C, display 322 may display a notification (e.g., text indicating a match) 325, as described more fully below.

During operation, according to various embodiments, embedding model 312 may be configured to receive data (e.g., video and/or image data from cameras 310), and generate a vector representation (also referred to as “vectors”) of one or more objects (e.g., person, vehicle, or other object) in the data. Each vector representation generated via embedding model 312 may be stored in database 316. Further, data from cameras 310 may be received at video recorder system 314, which may record the data (e.g., images and/or video) in database 318. According to various embodiments, vectors stored in database 316 may be correlated to data stored in database 318. In other words, a vector of a detected object may be correlated to image and/or video data depicting the object. As will be appreciated, a vector of a detected object may be correlated (i.e., linked) to associated video footage (i.e., footage including the object) via any known any known and suitable method, such as a vector similarity metric (e.g., via cosine similarity and/or dot product similarity).

Further, embedding model 324 may be configured to generate a vector representation based on an input (e.g., text (e.g., describing an object) and/or image and/or video data (e.g., depicting an object)). It is noted that model 312 and model 324 may include the same or similar weights, such that vector representations generated by models 312 and 324 may be similar or the same (e.g., exist within the same or similar space) assuming the same or similar input.

Various example scenarios (e.g., use cases) will now be described with reference to FIGS. 3A and 3B. It is noted that these are provided as non-limiting examples only, and other examples are within the scope of the disclosure.

In one example scenario, a user may search for relevant data (e.g., image and/or video). In this example, a user may enter (e.g., via a user device), for example, a plain text search (e.g., describing one or more objects) into search bar 320 of user interface 308. For example, from a user's perspective, a text search may function similarly to semantic search functionality. For example, a user can search for objects (e.g., “red shirt,” “blue truck,” “garbage can,” “brown dog,” “hat,” etc.), and one or more video clips including the search for objects may be identified.

Further, upon receipt of the text search, model 324 may generate a vector representation of the object described in the plain text, and the generated vector representation may be conveyed to one or more units (e.g., edge devices) 302, where the vector representation may be compared to vector representations stored in database 316 (i.e., at each unit 302). Responsive to the vector representation sent from model 324 matching at least one vector representation in database 316, data (e.g., including one or more relevant images and/or videos) associated with the matching vector (i.e., from database 316) may be identified and retrieved from database 318, and sent to user device 306, which may display the results (e.g., the relevant images and/or videos) via display 322. It is noted that each unit 302 that detects a match may send associated data (e.g., images and/or video) to user device 306. It is further noted that in addition to, or rather than, sending the relevant images and/or videos to user device 306, timestamps and/or links to the relevant images and/or videos may be sent to user device 306 (e.g., for later access and/or retrieval).

In the example of FIG. 3A, it will be appreciated that text describing an object (e.g., a missing person, a person of interest, a vehicle, without limitation) may be entered by a user and received at model 324, where a vector representation of the object may be generated. Moreover, as will be appreciated, the generated vector representation may be sent to a number of units 302 (e.g., positioned throughout an area, such as a city, a town, a state, etc.), such that any other images and/or videos of the object (e.g., the missing person, the person of interest, the vehicle) captured via one or more of units 302 may be identified.

In another example scenario, a user may select an object (e.g., a person or a vehicle) in an image and/or a video, and the selected object may be provided to model 324, which may generate a vector representation of the selected object. It is noted that the image and/or video that includes the object may exist at server 304, on user device 306, or another device (e.g., unit 302). Further, the generated vector representation of the selected object may be conveyed to one or more units (e.g., edge devices) 302, where the vector representation may be compared to vector representations stored in database 316 (i.e., at each unit 302). Responsive to the vector representation sent from model 324 matching at least one vector representation in database 316, data (e.g., including one or more relevant images and/or videos) associated with the matching vector (i.e., from database 316) may be identified and retrieved from database 318, and sent to user device 306, which may display the results (e.g., the relevant images and/or videos) via display 322. It is noted that each unit 302 that detects a match may send associated data (e.g., images and/or video) to user device 306. As noted above, in addition to, or rather than, sending the relevant images and/or videos to user device 306, timestamps and/or links to the relevant images and/or videos may be sent to user device 306 (e.g., for later access and/or retrieval).

In the example of FIG. 3B, it will be appreciated that an image of an object (e.g., a missing person, a person of interest, vehicle, without limitation)selected by a user may be received at model 324, where a vector representation of the object may be generated. Moreover, as will be appreciated, the vector representation may be sent to a number of units 302 (e.g., positioned throughout an area, such as a city, a town, a state, etc.), such that any other images and/or videos of the object (e.g., the missing person, the person of interest) captured via one or more of units 302 may be identified.

In yet another example scenario, a user may wish to determine if a previously identified object is reidentified (e.g., by a system, such as system 300). In this example, a user may select an object of interest (e.g., a person or a vehicle) in an image and/or a video, and the selected object may be provided to model 324, which may generate a vector representation of the selected object of interest. Further, the generated vector representation of the selected object of interest may be conveyed to one or more units (e.g., edge devices) 302, where the vector representation may be stored (e.g., in a database) and compared to subsequently generated vectors (i.e., as images and/or videos are captured respective units). According to various embodiments, unit 302 may include a program 330 to monitor identified vectors (i.e., representing objects of interest) and compare the identified vectors to vector representations at a unit, as the vector representations are generated at the unit (i.e., based on data captured by the unit).

Responsive to a match of the vector representation of the selected object of the interest to a generated vector representation (i.e., generated at unit 302), a notification may be provided to user device 306 (e.g., from the specific unit 302) and displayed via display 322.

In the example of FIG. 3C, it will be appreciated that an image of an object (e.g., a missing person, a person of interest, without limitation) may be selected by a user and received at model 324, where a vector representation of the object may be generated. Moreover, as will be appreciated, the vector representation may be sent to a number of units 302 (e.g., positioned throughout an area, such as a city, a town, a state, etc.), such that a subsequent capture of the object (e.g., the missing person, the person of interest) via one or more units 302 may be identified. Thus, as will be appreciated, the units may be configured to “look out for” a specific object, and responsive to the specific object being detected, a notification may be provided.

FIG. 4 depicts a system 400, in accordance with various embodiments of the disclosure. System 400 includes a number of mobile unit 402 (e.g., 402_1-402_N), a server 404, and one or more electronic devices 406. In one non-limiting example, mobile unit 402 includes mobile unit 202 (see FIG. 2) and/or unit 302 (see FIGS. 3A and 3B), server 404 may include a cloud server or any other server (e.g., server 304 of FIGS. 3A and 3B), and device(s) 406 may include an electronic device (e.g., electronic devices 113 (see FIG. 1) or user device 306 (see FIGS. 3A-3C)), such as a front-end device (e.g., a user device (e.g., mobile phone, tablet, etc.), a desktop computer, or any other suitable electronic device (e.g., including a display)). According to various embodiments, each of server 404 and electronic device(s) 406 may be remote from mobile unit 402. Further, for example, server 404 may include a cloud-based processor.

According to various embodiments of the disclosure, each mobile unit 402, which may include a modem, may be within a first location (a “camera locations” or a “remote locations”), and server 404 may be within a second location, remote from the camera location. For example, each mobile unit may be positioned in or near an environment, such as a parking lot, a roadside location, a construction zone, a concert venue, a sporting venue, a school campus, without limitation. In addition, in at least some examples, electronic device 406 may be remote from each mobile unit 402 and/or server 404. As will be appreciated by a person having ordinary skill in the art, system 400 may be modular, expandable, and/or scalable.

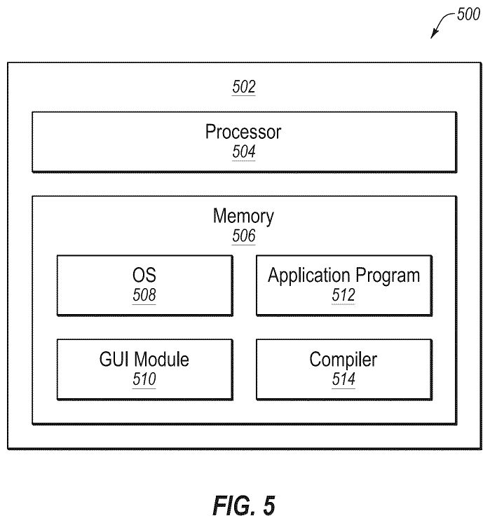

FIG. 5 illustrates a system 500 that may be used to implement embodiments of the disclosure. System 500 may include a computer 502 that comprises a processor 504 and memory 506. In some examples, computer 502 may include computer 110 of FIG. 1.

For example only, and not by way of limitation, computer 502 may include a workstation, a laptop, or a hand-held device such as a cell phone or a personal digital assistant (PDA), a server (e.g., server 116), computer 110 (see FIG. 1), or any other processor-based device known in the art. In one embodiment, computer 502 may be operably coupled to a display (not shown in FIG. 5), which presents data (e.g., video and/or images) to the user via a GUI. As will be appreciated, computer 502 may include one or controllers including one or more operating systems, which may be configured and/or updated in accordance with various embodiments disclosed herein.

Generally, computer 502 may operate under control of an operating system 508 stored in memory 506, and interface with a user to accept inputs and commands and to present outputs through a GUI module 510. Although GUI module 510 is depicted as a separate module, the instructions performing the GUI functions may be resident or distributed in the operating system 508, a program 512, or implemented with special purpose memory and processors. Computer 502 may also implement a compiler 514 that allows a program 512 (e.g., code) written in a programming language to be translated into processor 504 readable code. After completion, program 512 may access and manipulate data stored in memory 506 of computer 502 using the relationships and logic that are generated using compiler 514.

Further, operating system 508 and program 512 may include instructions that, when read and executed by computer 502, may cause computer 502 to perform the steps necessary to implement and/or use various embodiments of the disclosure. Program 512 and/or operating instructions may also be tangibly embodied in memory 506 and/or data communications devices, thereby making a computer program product or article of manufacture according to an embodiment of the present disclosure. As such, the term “program” as used herein is intended to encompass a computer program accessible from any computer readable device or media. Program 512 may exist on an electronic device (e.g., electronic device 113; see FIG. 1), a server (e.g., server 116; see FIG. 1), a unit (e.g., unit 102; see FIG. 1), and/or another device. Furthermore, portions of program 512 may be distributed such that some of program 512 may be included on a computer readable media within an electronic device (e.g., electronic device 113), some of program 512 may be included on a computer readable media on a server (e.g., server 116), some of program 512 may be included on a computer readable media on a surveillance unit (e.g., unit 102, unit 302, and/or mobile unit 402), and/or some of program 512 may be included on a computer readable media on another device. For example, with reference to FIG. 1, in some embodiments, program 512 may be configured to run on electronic device 113, server 116, unit 102, another computing device, or any combination thereof. As a specific example, program 512 may exist on server 116 and/or unit 102 and may be accessible to a user via electronic device 113.

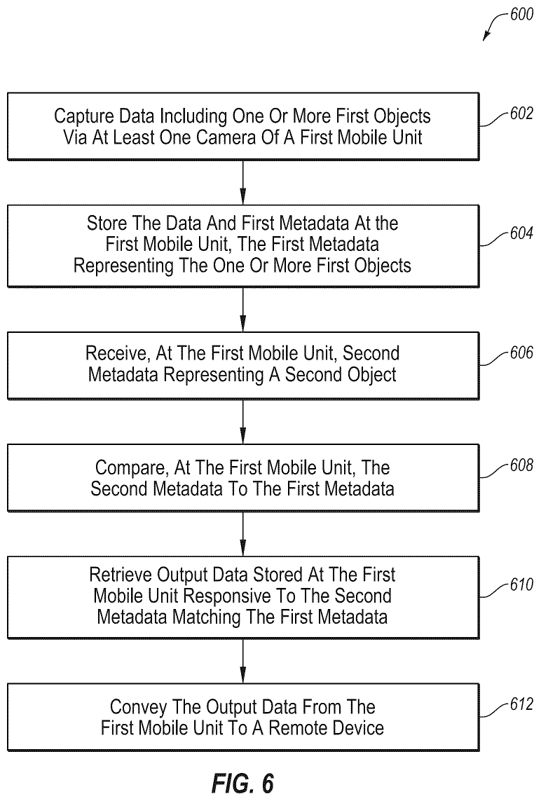

FIG. 6 is a flowchart of an example method 600 of operating a surveillance system. Method 600 may be arranged in accordance with at least one embodiment described in the disclosure. Method 600 may be performed, in some embodiments, by a device or system, such as system 100 (see FIG. 1), system 200 (see FIG. 2), system 300 (FIGS. 3A-3C), system 400 (see FIG. 4), system 500 (see FIG. 5), or another device or system. Although illustrated as discrete blocks, various blocks may be divided into additional blocks, combined into fewer blocks, or eliminated, depending on the desired implementation.

Method 600 may begin at block 602, wherein data including one or more first objects may be captured via at least one camera of a mobile unit, and method 600 may proceed to block 604. For example, video data and/or image data including the one or more first objects (e.g., a person, a vehicle, etc.) may be captured via camera 310 of unit 302 (see FIGS. 3A-3C).

At block 604, the captured data and first metadata may be stored at the mobile unit, and method 600 may proceed to block 606. For example, the first metadata represents the one or more first objects of the captured data. For example, the captured data (e.g., video and/or image data) may be stored in database 318 and the first metadata, which may include, for example, a vector representation, may be stored in database 316 (see FIGS. 3A-3C).

At block 606, second metadata representing a second object may be received at the mobile unit, and method 600 may proceed to block 608. For example, the second metadata, which may include a vector representation, may be received from model 324 (see FIGS. 3A-3C). For example, the second metadata may be generated based on user input (e.g., a text search entered by the user and/or a video or image selected by a user).

At block 608, the second metadata may be compared to the first metadata at the mobile unit, and method 600 may proceed to block 610.

At block 610, output data may be retrieved at the mobile unit responsive to the second metadata matching the first metadata, and method 600 may proceed to block 612. For example, responsive to the second metadata matching the first metadata, video and/or image data associated with the first metadata may be retrieved (e.g., from database 318 of FIGS. 3A-3C).

At block 612, the output data may be conveyed from the mobile unit to a remote device. For example, the video and/or image data associated with the first metadata and retrieved from database 318 may be conveyed from the mobile unit 302 to user device 306, such that the video and/or image data may be displayed via display 322 of user interface 308 of user device 306 (see FIGS. 3A-3C).

Modifications, additions, or omissions may be made to method 600 without departing from the scope of the present disclosure. For example, the operations of method 600 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment. For example, method 600 may include one or more acts wherein the first metadata is generated via a first model responsive to receipt of the data at the first model. Further, method 600 may include one or more acts wherein generating the second metadata is generated via a second model responsive to input received at the second model. Moreover, method 600 may include one or more acts wherein the one or more objects are captured in at least one of an image or a video via the mobile unit.

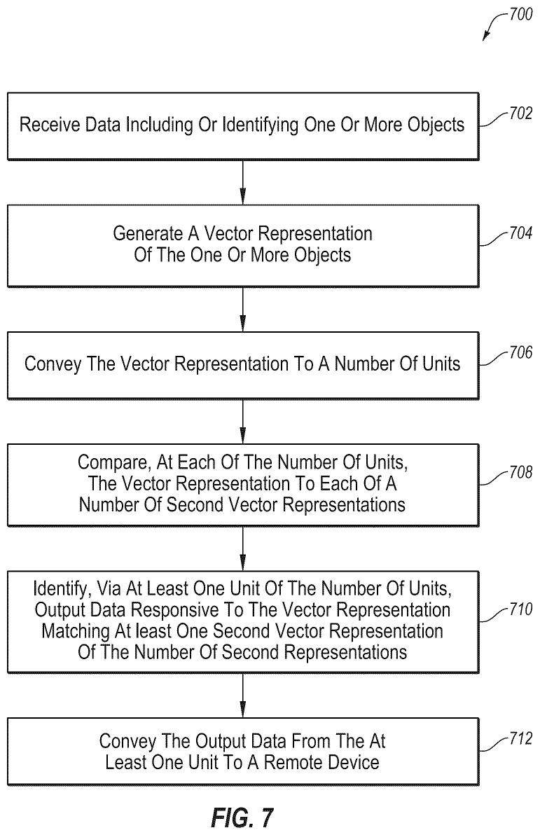

FIG. 7 is a flowchart of an example method 700 of operating a surveillance system. Method 700 may be arranged in accordance with at least one embodiment described in the disclosure. Method 700 may be performed, in some embodiments, by a device or system, such as system 100 (see FIG. 1), system 200 (see FIG. 2), system 300 (FIGS. 3A-3C), system 400 (see FIG. 4), system 500 (see FIG. 5), or another device or system. Although illustrated as discrete blocks, various blocks may be divided into additional blocks, combined into fewer blocks, or eliminated, depending on the desired implementation.

Method 700 may begin at block 702, wherein data including or identifying one or more objects may be received, and method 700 may proceed to block 704. For example, text data, image data, and/or video data including and/or identifying the one or more objects may be received at model 324 (e.g., of server 304).

At block 704, a vector representation of the one or more objects may be generated, and method 700 may proceed to block 706. For example, model 324 (see FIGS. 3A-3C), which may include an embedding model, may generate a vector representation based on the received data.

At block 706, the vector representation may be conveyed to a number of units, and method 700 may proceed to block 708. For example, the vector representation may be conveyed to units 302 (see FIGS. 3A-3C).

At block 708, the vector representation may be compared to each of a number of second vector representations, and method 700 may proceed to block 710. For example, at each of the number of units 302, the vector representation may be compared to vector representations stored in database 316 (i.e., of each unit 302).

At block 710, output data may be generated responsive to the vector representation matching at least one second vector representation of the number of second representations and method 700 may proceed to block 712. For example, responsive to the vector representation matching at least one second vector representation, video and/or image data associated with the at least one second vector representation may be retrieved (e.g., from database 318 of FIGS. 3A-3C).

At block 712, the output data may be conveyed from the at least one unit to a remote device. For example, the video and/or image data associated with the at least one second vector representation and retrieved from database 318 may be conveyed from at least one unit 302 to user device 306, such that the video and/or image data may be displayed via display 322 of user interface 308 of user device 306 (see FIGS. 3A-3C).

Modifications, additions, or omissions may be made to method 700 without departing from the scope of the present disclosure. For example, the operations of method 700 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment. For example, method 700 may include one or more acts wherein video data is received at each of the number of units, and the number of second vector representations are generated based on the received video data.

In accordance with common practice, the various features illustrated in the drawings may not be drawn to scale. The illustrations presented in the disclosure are not meant to be actual views of any particular apparatus (e.g., circuit, device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., circuit, device, or system) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. As used herein, “and/or” includes any and all combinations of one or more of the associated listed items.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc. ,” or “one or more of A, B, and C, etc. ,” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

As used herein, the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, the term “approximately” or the term “about,” when used in reference to a numerical value for a particular parameter, is inclusive of the numerical value and a degree of variance from the numerical value that one of ordinary skill in the art would understand is within acceptable tolerances for the particular parameter. For example, “about,” in reference to a numerical value, may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternative useful combinations of the elements described, will become apparent to those skilled in the art from the description. Such modifications and embodiments also fall within the scope of the appended claims and equivalents.

What is claimed:

1. A system including a number of mobile units, comprising:
a server; and
a number of mobile units communicatively coupled to the server, each mobile unit of the number of mobile units comprising:
at least one camera for capturing data including objects;
a first model for generating a number of first vector representations based on the objects of the captured data;
at least one database for storing the captured data and the number of first vector representations;
a communication device for receiving a second vector representation; and
at least one application program configured to:
compare the second vector representation to each of the number of first vector representations;
identify associated data of a specific vector representation of the first vector representations responsive to a match between the second vector representation and the specific vector representation; and
cause the associated data to be sent to a device via the communication device.

2. The system of claim 1, wherein the server comprises a second model to receive input and generate the second vector representation based on the input.

3. The system of claim 2, wherein the second model comprises an embedding model.

4. The system of claim 2, wherein the input comprises one or more of a text description of an object, a video of the object, or an image of the object.

5. The system of claim 4, further comprising a user device for generating or identifying the input.

6. The system of claim 1, wherein the first model comprises an embedding model to receive the captured data and generate the number of first vector representations.

7. The system of claim 1, wherein the at least one database comprises a first database for storing the number of first vector representations and a second database for storing the captured data.

8. The system of claim 1, wherein the associated data comprises video data, image data, or both.

9. A system, comprising:
a mobile surveillance unit comprising:
at least one camera for capturing data including one or more objects;
an application program including an artificial intelligence (AI) model for generating first metadata for at least one object of the one or more objects;
a database for storing the first metadata; and
a communication device for receiving second metadata;
the application program to:
compare second metadata to the first metadata;
retrieve output data responsive to the second metadata matching the first metadata; and
cause the output data to be conveyed to a remote device via the communication device.

10. The system of claim 9, wherein each of the first metadata and the second metadata comprises a vector.

11. The system of claim 9, wherein the output data comprises at least one of image data or video data, the application program further configured to identify the output data based on a correlation between the output data and the first metadata.

12. The system of claim 9, wherein:
the remote device comprises a user device; and
the second metadata is based on input received from the user device.

13. A method of operating a surveillance system, the method comprising:
capturing data including one or more first objects via at least one camera of a mobile unit;
storing the data and first metadata at the mobile unit, the first metadata representing the one or more first objects;
receiving, at the mobile unit, second metadata representing a second object;
comparing, at the mobile unit, the second metadata to the first metadata;
retrieving output data stored at the mobile unit responsive to the second metadata matching the first metadata; and
conveying the output data from the mobile unit to a remote device.

14. The method of claim 13, wherein the first metadata comprises a vector representation of the one or more first objects and the second metadata comprises a second vector representation of the second object.

15. The method of claim 13, further comprising:
generating the first metadata via a first model responsive to receipt of the data at the first model; and
generating the second metadata via a second model responsive to input received at the second model.

16. The method of claim 15, wherein generating the second metadata comprises generating the second metadata via the second model responsive to one of a text input, an image input, or a video input received at the second model.

17. The method of claim 13, further comprising capturing, via the at least one camera of the mobile unit, the one or more first objects in at least one of an image or a video.

18. A method of operating a surveillance system, the method comprising:
receiving data including or identifying one or more objects;
generating a vector representation of the one or more objects;
conveying the vector representation to a number of units;
comparing, at each of the number of units, the vector representation to each of a number of second vector representations;
identifying, via at least one unit of the number of units, output data responsive to the vector representation matching at least one second vector representation of the number of second representations; and
conveying the output data from the at least one unit to a remote device.

19. The method of claim 18, further comprising:
receiving video data at each of the number of units; and
generating the number of second vector representations based on the received video data.

20. The method of claim 13, wherein receiving data comprises receiving at least one of a text identifying the one or more first objects, a video including the one or more first objects, or an image including the one or more first objects.
